(19) United States
(12) Patent Application Publication
(10) Pub. No.: US 2007/0074673 A1
(43) Pub. Date: Apr. 5, 2007

(54) System and method for foaming liquid

(75) Inventor: Scott Charles Sprangers, Janesville, WI (US)

Correspondence Address: KENYON & KENYON LLP, 1500 K STREET N.W., SUITE 700, WASHINGTON, DC, 20005, US

(73) Assignee: Pro-Chemicals LLC, Green Bay, WI (US)

(21) Appl. No.: 11/239,158

(22) Filed: Sep. 30, 2005

(51) Int. Cl. A01K 29/00

(52) U.S. Cl. 119/670

(57) ABSTRACT

A system and method for producing a bovine teat foam for treating a bovine teat is provided. This method may include providing a foaming system that has an open ended teat cup fluidly connected to a pressurized line containing a bovine teat liquid treatment and creating the foam passing the liquid treatment through a screen before the liquid reaches the bovine teat. In this method the provided system may also include a body having a beveled surface and a thimble shaped screen positioned within the body. Also, the bovine teat treatment may comprise iodine-based and glycerin-based treatments as well as other types. As explained throughout the disclosure, there are numerous other embodiments of the invention in addition to those specifically disclosed herein.

### SYSTEM AND METHOD FOR FOAMING LIQUID

The present invention regards systems, methods, and apparatus for foaming. More particularly, the present invention regards a liquid foaming system, method and apparatus for producing foam in an open ended cup that may be used to apply the foam to a bovine teat.

### BACKGROUND

The process of bovine milking has become more automated and efficient over time. Contemporary milking systems often include placing a milking tube around the bovine's teats each time milk is drawn. To reduce the risk of irritation and infection the bovine's teats may be cleaned before or after milking. This cleaning may be carried out with various liquid chemicals that are formulated to clean and otherwise protect the teat. Pro-Chemicals LLC is a supplier of these chemicals. These chemicals, or “dips,” may be applied to the teats as a liquid and as a foam.

This application provides methods, systems and devices for foaming liquids that may be used as a bovine teat dip as well as for other purposes.

### SUMMARY OF THE INVENTION

A system and method for producing a bovine teat foam for treating a bovine teat is provided. This method may include providing a foaming system that has an open ended teat cup fluidly connected to a pressurized line containing a bovine teat liquid treatment and creating the foam passing the liquid treatment through a screen before the liquid reaches the bovine teat. In this method the provided system may also include a body having a beveled surface and a thimble shaped screen positioned within the body. Also, the bovine teat treatment may comprise iodine-based and glycerin-based treatments as well as other types. As explained throughout the disclosure, there are numerous other embodiments of the invention in addition to those specifically disclosed herein.

### BRIEF DESCRIPTION OF THE DRAWINGS

FIG. 1 is a side elevation of a system embodying the present invention.

FIG. 2 is a side elevation of a screen that may be employed in an embodiment of the present invention.

FIG. 3 is a sectional view along line 3-3 of FIG. 2.

FIG. 4 is a sectional view along line 4-4 of FIG. 2.

FIG. 5 is a detailed elevation of the coupling from the system of FIG. 1.

FIG. 6 is a detailed elevation of the coupling from the system of FIG. 1.

FIG. 7 is a detailed elevation of the coupling from the system of FIG. 1.

### DETAILED DESCRIPTION

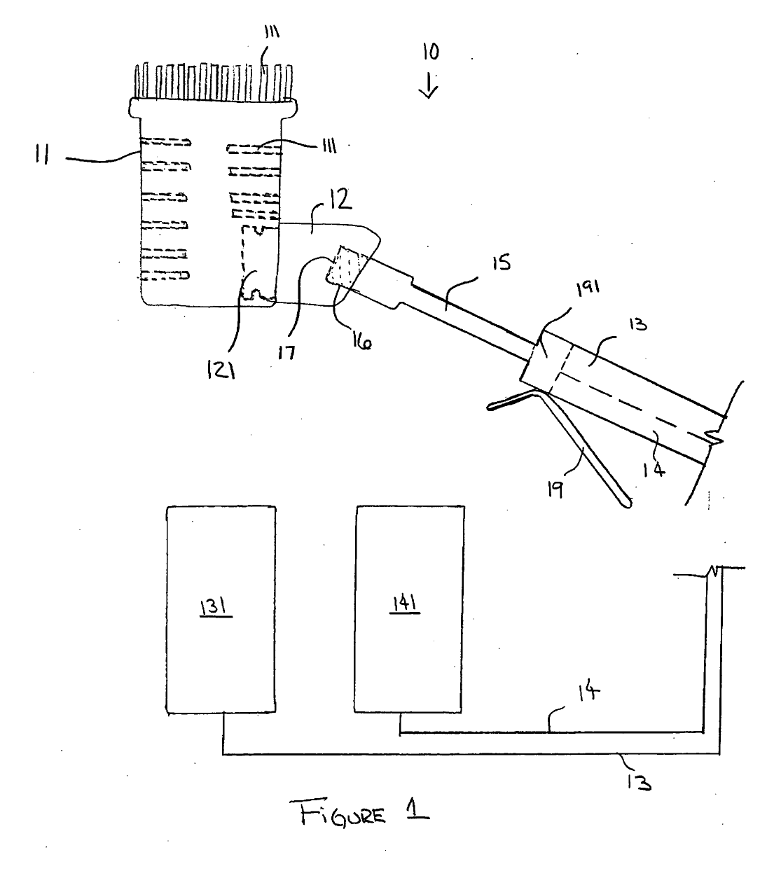

FIG. 1 is an elevation of a foaming system 10 embodying the present invention. This embodiment, like the others described herein is illustrative of the invention and may be modified or combined with other embodiments and remain within the scope of the invention.

Visible in FIG. 1 is a teat cup 11, a coupling 12, a chemical line 13, a compressed gas line 14, a trigger 19, a compressed gas source 141, a chemical storage container/drum 131, and a mixing line 15. These components are coupled together in a sealed fashion such that they may provide a foam in the teat cup 11, of the chemical stored in the container/drum 131, when the trigger 19 is depressed.

The teat cup 11 in this figure is shown with an open top 18, a receiving opening 110, and internal stimulating fingers 111. The teat cup may be made from a rigid polymer to form the shape of the cup and a more pliable one to form the fingers within the cup. An example of the fingers 111 in the teat cup is found in FIGS. 1-5 of U.S. Pat. No. 6,302,058, the illustrations of which are incorporated herein.

The coupling 12 in this embodiment is shown with an insert 121 sized to sealingly fit within the opening 110, a beveled face 122, a tubular main body 123, and a threaded recess 16. Positioned within and at the end of the threaded recess 16 is a screen 17. The screen 17 may be thimble shaped and may be inserted into the recess 16 and held in place when the mixing line 15 is screwed into the coupling 12. The screen may be made from a 60 ×60 mesh of 0.0075 diameter stainless steel wire. The insert 121 of the coupling in this embodiment has an annular indentation within it to help secure the coupling 12 to the teat cup.

The mixing line 15 in this embodiment may have the trigger 19 coupled to it or the trigger may be located further downstream of the teat cup 11. The mixing line may be made from stainless steel and may have a threaded end that is sized to fit within the threaded recess 16 as well as an opposite end that is adapted to connect to the pressurized line 14 and the chemical line 13. The trigger may be connected to a valve that acts to release compressed gas and chemical into the mixing line 15. The chemicals and compresses gas may be mixed at other positions in the system as well and may then be released into the coupling and teat cup when the trigger is activated.

The pressurized line 14 may be connected to a compressed gas source 141, which may be a compressor, storage tank, or other compressed gas source. Suitable gases that may be compressed include air and carbon dioxide. The chemical line 13 may be connected to a foaming chemical container/drum 131 which itself may be a bucket or drum of surfactant or other chemical treatment that may be used to treat or pre-treat a bovine teat. This surfactant, chemical or other liquid may be drawn from the container/drum by the siphoning effect created by the pressurized line 14 or the gas source 141, it may also be forced from the container/drum 131 through the use of compressed gas from another source.

The chemical container/drum 131 may contain a wide variety of chemicals including chemicals that may be used to treat or pre-treat a bovine teat. These chemicals or dips may include dip such as “New,” “Re-New” and “Perox-100” brand dips formulated and sold by Pro-Chemicals LLC of Green Bay, WI. It may also include others, including dips that are iodine based or glycerine based as well as those that contain clorahexadine, paracedic acid, hydrogen peroxide, quartemary amonia, alcohol, and surfactant based compounds.

In use, the foaming system 10 of FIG. 1 may be used to apply a foam to a bovine teat before and after milking the teat. An operator of the device may depress the trigger 19 to release a mixture of chemical and gas through the screen I and into the cup 11. As the compressed gas and chemical passes the valve opened by the trigger 19, the compressed gas will expand and will create a foam of the liquid as the mixture of gas and liquid passes through the screen 17. The foam, now present in the cup, may be applied to a bovine teat before or after milking by an operator of the foaming system 10.

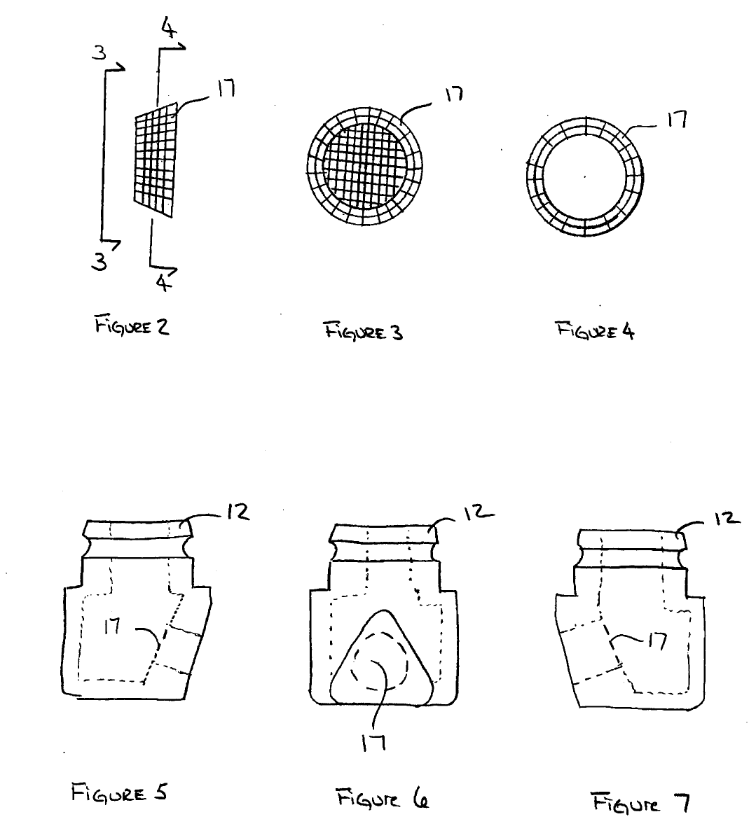

FIGS. 2-4 show the screen 17 of FIG. 1. This screen, like the foaming system 10 of FIG. 1, may be shaped in other configurations while remaining within the scope of the present invention. FIG. 2 is a side view of the screen 17. As can be seen it is thimble shaped and has a flat surface 21, this surface 21 is the surface that decompressing gas and dip mixture passing into the coupling 12 will pass as the mixture is foamed. FIG. 3 is a sectional view taken along line 3-3 of FIG. 2 while FIG. 4 is a sectional view taken along line 4-4 of FIG. 2. The screen 17 is shown in an uncompressed state outside of the recess in the coupling 12 in which it is placed. In this condition the side walls of the screen 17 extend outward. Comparatively, when the screen 17 is placed in the recess of the coupling 12, the screen walls will contract in to conform to the walls of the recess 16. This screen may be made from a flexible mesh of stainless steel as well as other materials.

FIGS. 5-7 show an elevation of the coupling 12 in accord with an embodiment of the present invention. The tubular body 123, beveled surface 122, and recess 16 are clearly visible in these figures. The coupling 12 may be made from plastic or some other durable material. Likewise, it may numerous other shapes and configurations, including its size and where and how the mixing line and teat cup are connected to it. If the coupling is configured to contain the screen 17, as is the case in this embodiment, it is preferred that the coupling be adapted to hold the screen securely in place when the mixture of gas and chemicals are expanding and foaming through the screen 17.

As indicated above, other devices and methods may also embody the present invention. For instance, rather than having two lines connected immediately prior to the mixing line 15, these lines may be a single line connected to a pressurized container/drum of chemicals. Likewise, rather than placing the screen 17 in the coupling 12, the screen 17 may be placed in the teat cup 11 itself and the pressurized line may be directly coupled to the teat cup. In this case the foam may then be formed at or near the bottom of the teat cup 11.

What is claimed is:

1. A method for foaming a bovine teat liquid treatment, the method comprising:
providing a foaming system that includes an open ended cup fluidly connected to a line containing a bovine teat liquid treatment at a pressure greater than atmospheric pressure;
foaming the bovine teat liquid treatment by passing it through a screen.

2. The method of claim 1 wherein the line containing a bovine teat liquid treatment at a pressure greater than atmospheric pressure is fluidly coupled to a container/drum of bovine treatment and fluidly coupled to a source of pressurized gas.

3. The method of claim 1 further comprising:
providing a body between the open ended cup and the line containing a bovine teat liquid treatment at a pressure greater than atmospheric pressure, the body containing the screen.

4. The method of claim 1 wherein the screen is a stainless steel screen.

5. The method of claim 1 wherein the screen is in the shape of a thimble.

6. The method of claim 1 further comprising:
providing a source of compressed gas remote from the cup, the source of compressed gas coupled to a source of bovine teat liquid treatment.

7. The method of claim 1 further comprising:
providing a source of compressed gas remote from the cup, the source of compressed gas coupled to the line containing a bovine teat liquid treatment.

8. The method of claim 1 wherein the screen is positioned outside of the cup.

9. The method of claim 1 further comprising:
engaging a trigger to allow the bovine teat liquid treatment to pass through the screen.

10. The method of claim 3 wherein the body has a beveled surface and a recess shaped to receive the screen.

11. The method of claim 1 wherein the bovine teat liquid treatment is an iodine-based solution.

12. The method of claim 1 wherein the cup is sized to surround a bovine teat.

13. The method of claim 1 wherein the bovine teat liquid treatment is a glycerin-based solution.

14. The method of claim 1 wherein the screen comprises a planar wire mesh.

15. The method of claim 1 wherein the screen is thimble shaped and has a planar area through which the liquid treatment passes as the liquid treatment is being foamed.
